(19) United States
(12) Patent Application Publication
(10) Pub. No.: US 2017/0364144 A1
(43) Pub. Date: Dec. 21, 2017

(54) Systems and Methods for Displaying Virtual-Reality Images on a Convertible Wired/Mobile Head-Mounted Display

(71) Applicant: OCULUS VR, LLC, Menlo Park, CA (US)

(72) Inventor: Yury Anatolievich Petrov, Half Moon Bay, CA (US)

(21) Appl. No.: 15/186,340

(22) Filed: Jun. 17, 2016

(51) Int. Cl. G06F 3/01; G02B 27/01

(52) U.S. Cl. CPC G06F 3/012; G02B 27/0179; G02B 27/0176; G02B 2027/0154; G02B 2027/0138; G02B 2027/0163; G02B 2027/0187; G02B 2027/0152

(57) ABSTRACT

A virtual-reality (VR) system includes a head-mounted display (HMD) to receive video input from a stationary computer in a first mode of operation and from a mobile computer in a second mode of operation, and to display images corresponding to the video input. The VR system also includes a headband to secure the HMD on a user's head and a holder mounted on the headband to detachably support the mobile computer.

### TECHNICAL FIELD

This application relates generally to wearable technology and virtual-reality technology, including but not limited to a head-mounted display capable of displaying images generated on a stationary computer (e.g., a desktop computer) and images generated on a mobile computer (e.g., a smartphone) on the same headset.

### BACKGROUND

Virtual-reality (VR) head-mounted displays (HMDs) have wide applications in various fields, including engineering design, medical surgery practice, military simulated practice, and video gaming. Some head-mounted displays include a mobile device for rendering and displaying images and a headset configured to dock with the mobile device.

The aforementioned conventional head-mounted displays lack the ability for a user to enjoy the convenience of viewing high-quality VR video as well as enjoy the convenience of being immersed in the VR experience without any constraints on the user movement. Furthermore, the aforementioned HMD having the mobile device docked in the front of the HMD creates additional weight on the front of the user's head, thereby causing user fatigue due to the imbalance of the HMD on the user's head.

### SUMMARY

Accordingly, there is a need for virtual-reality systems capable of producing and rendering VR images from high-quality videos provided by stationary computers and VR images from video provided by mobile computers on the same headset so as to allow the user to view high-quality images during intensive use (e.g., “high-CPU” gameplay) and allow movement of the user to not be constrained by long cables to a standalone computer while using the HMD. There is a further need for virtual-reality systems capable of reducing user fatigue which is due to an imbalance of a weight of the HMD exerted on the front of the headset.

In accordance with some embodiments, a VR system includes a HMD to receive video input from a stationary computer in a first mode of operation and from a mobile computer in a second mode of operation, and to display images corresponding to the video input. The VR system further includes a headband to secure the HMD on a user's head, and a holder mounted on the headband to detachably support the mobile computer.

In some embodiments, the virtual-reality system further includes a first cable to communicatively couple the stationary computer to the HMD in the first mode of operation, and a second cable to communicatively couple the mobile computer to the HMD in the second mode of operation. The second cable is shorter than the first cable.

In some embodiments, the holder is mounted to a back section of the headband to at least partially balance a weight of the HMD on the user's head when the mobile computer is supported in the holder.

In some embodiments, the holder is configured to support the mobile computer and a power source on the headband.

In some embodiments, the power source is a battery selected from the group consisting of a lithium-polymer battery and a lithium-ion battery.

In some embodiments, the holder is rotatably coupled to the back section for adjustment of an angle of orientation of the mobile computer.

In some embodiments, the holder is detachably coupled to the back section.

In some embodiments, the holder is integrally formed with the back section.

In some embodiments, the holder is adjustable to accommodate a plurality of sizes of the mobile computer.

In some embodiments, the HMD includes an interface positioned on an outer surface of the HMD to allow for access during switching between the first and second modes, the first cable communicatively couples the stationary computer to the HMD through the interface in the first mode of operation, and the second cable communicatively couples the mobile computer to the HMD through the interface in the second mode of operation.

In some embodiments, the mobile computer includes at least one position sensor to track a motion of the user's head in the second mode.

In some embodiments, the mobile computer includes at least one camera to track a position of the user in the second mode.

In some embodiments, a display of the mobile computer is configured to deactivate in the second mode to conserve power of the mobile computer.

In some embodiments, the virtual-reality system further includes a plurality of light-emitting diodes (LEDs) coupled to at least one of the HMD and the headband. The plurality of LEDs is configured to be activated in the first mode and deactivated in the second mode.

In accordance with some embodiments, a method for displaying VR images produced by a VR system includes in a first mode of operation, receiving, by a HMD of the VR system, a first video input from a stationary computer, and displaying, by the HMD, images corresponding to the first video input. The method further includes in a second mode of operation, receiving, by the HMD, a second video input from a mobile computer mounted in a holder on a headband of the VR system. The holder is configured to detachably support the mobile computer and the headband is configured to secure the HMD on a user's head. The method further includes displaying, by the HMD, images corresponding to the second video input.

In some embodiments, the method further includes, in the second mode, deactivating a display of the mobile computer to conserve power of the mobile computer.

In some embodiments, in the first mode, the HMD receives the first video input through a first cable communicatively coupling the stationary computer to a VR interface of the HMD, and in the second mode, the HMD receives the second video input through a second cable communicatively coupling the mobile computer to the VR interface. The second cable is shorter than the first cable.

In some embodiments, the holder is mounted to a back section of the headband to at least partially balance a weight of the HMD on the user's head when the user wears the HMD.

In some embodiments, the method further includes, in the second mode, tracking a motion of the user's head, by at least one position sensor of the mobile computer, and translating the motion to produce a corresponding motion of the images displayed on the HMD.

In some embodiments, the method further includes, in the second mode, tracking a position of the user, by at least one camera of the mobile computer, to produce a corresponding motion of the images displayed on the HMD.

### BRIEF DESCRIPTION OF THE DRAWINGS

For a better understanding of the various described embodiments, reference should be made to the Detailed Description below, in conjunction with the following drawings. Like reference numerals refer to corresponding parts throughout the figures and description.

FIG. 1 is a perspective view of a head-mounted display of a VR system in accordance with some embodiments.

FIG. 2 is a back view of a VR system including a head-mounted display communicatively coupled to a stationary computer in a first mode of operation in accordance with some embodiments.

FIG. 3A is a back view of a VR system including a head-mounted display communicatively coupled to a mobile computer in a second mode of operation, in accordance with some embodiments.

FIG. 3B and FIG. 3C are side perspective views of a VR system including the head-mounted display in accordance with some embodiments.

FIG. 4 is a block diagram illustrating an electrical configuration of the VR system in accordance with some embodiments.

FIG. 5 is a flow diagram illustrating a method of displaying VR images produced by a VR system in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known systems, methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first mode could be termed a second mode, and, similarly, a second mode could be termed a first mode, without departing from the scope of the various described embodiments. The first mode and the second mode are both modes, but they are not the same mode.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

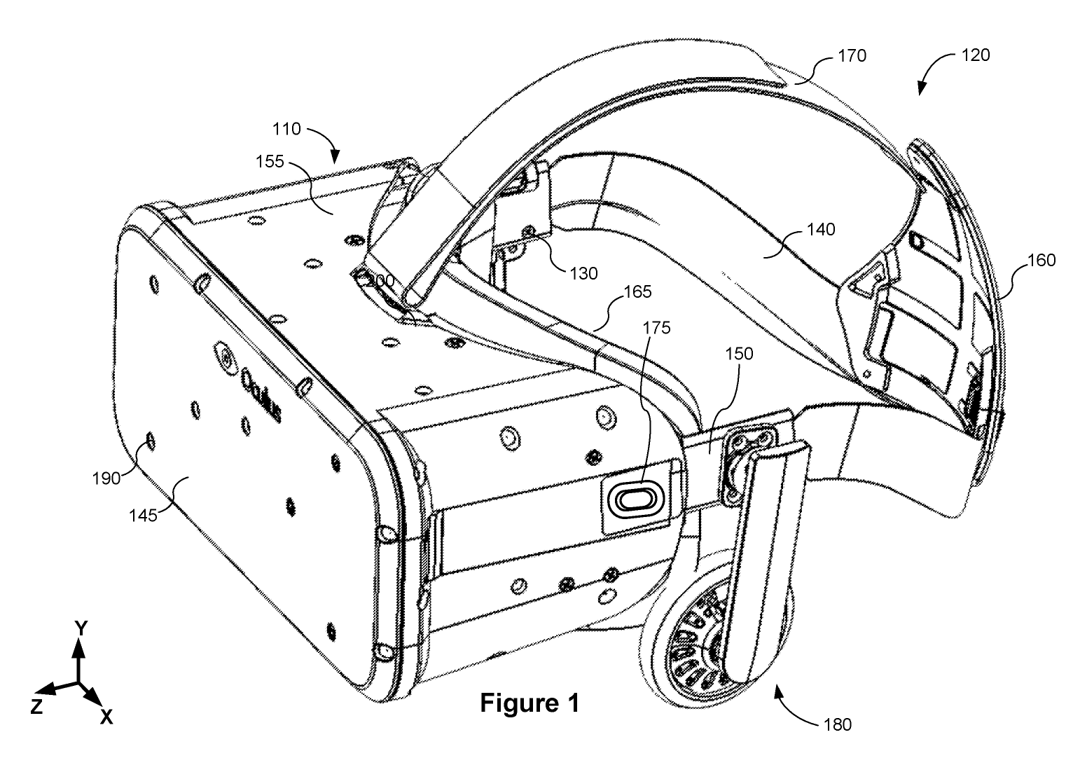

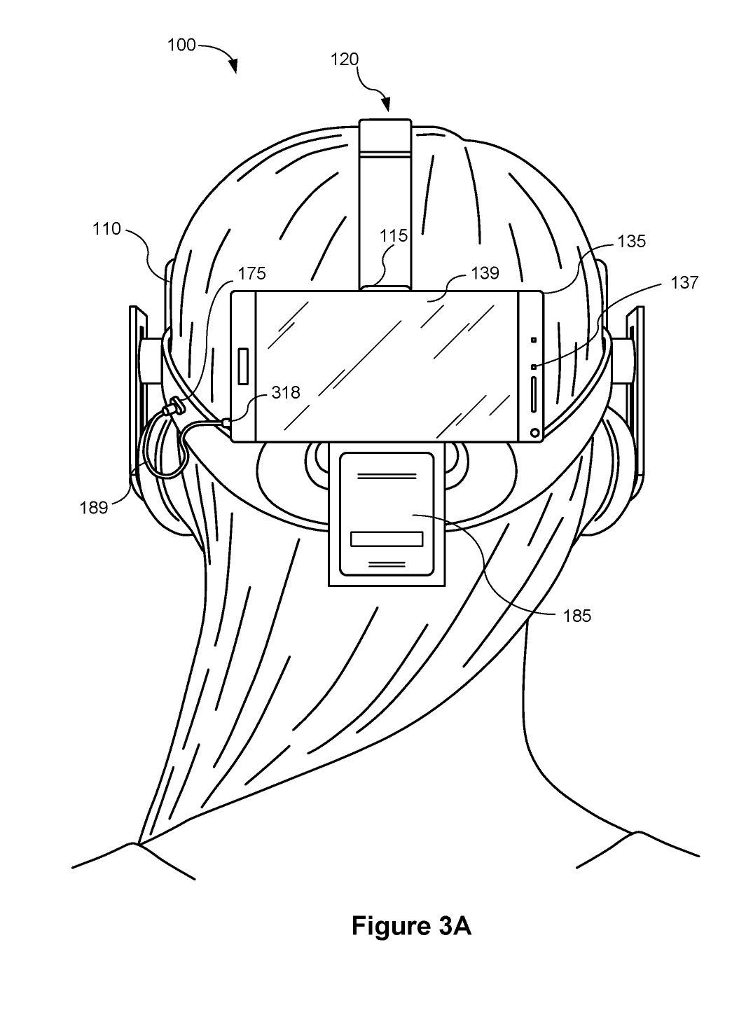

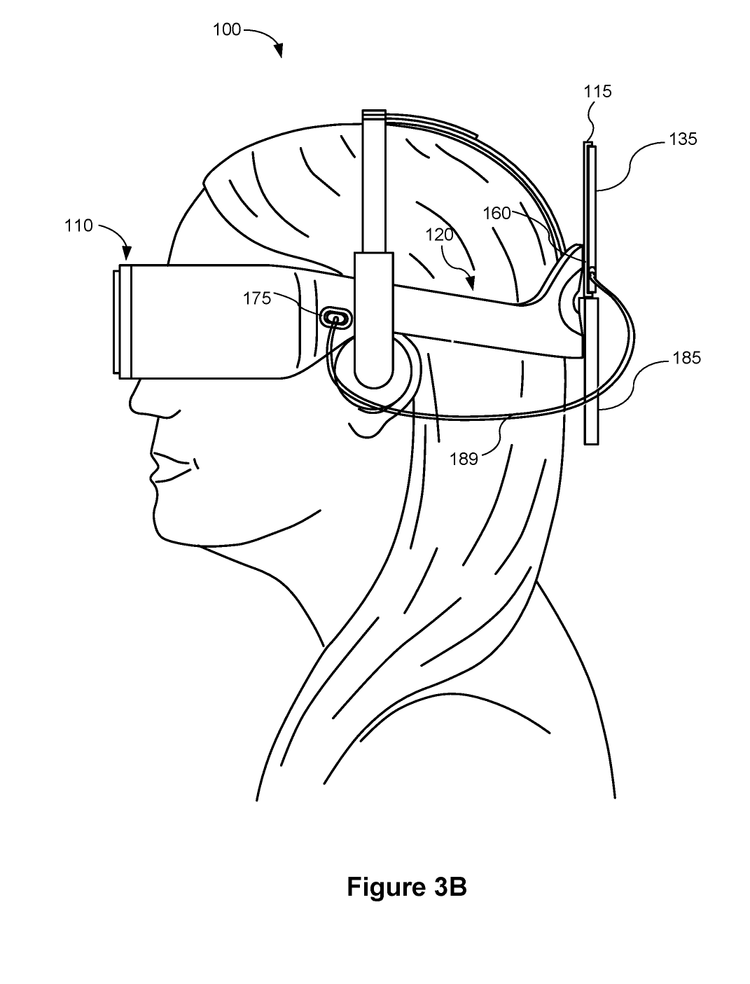

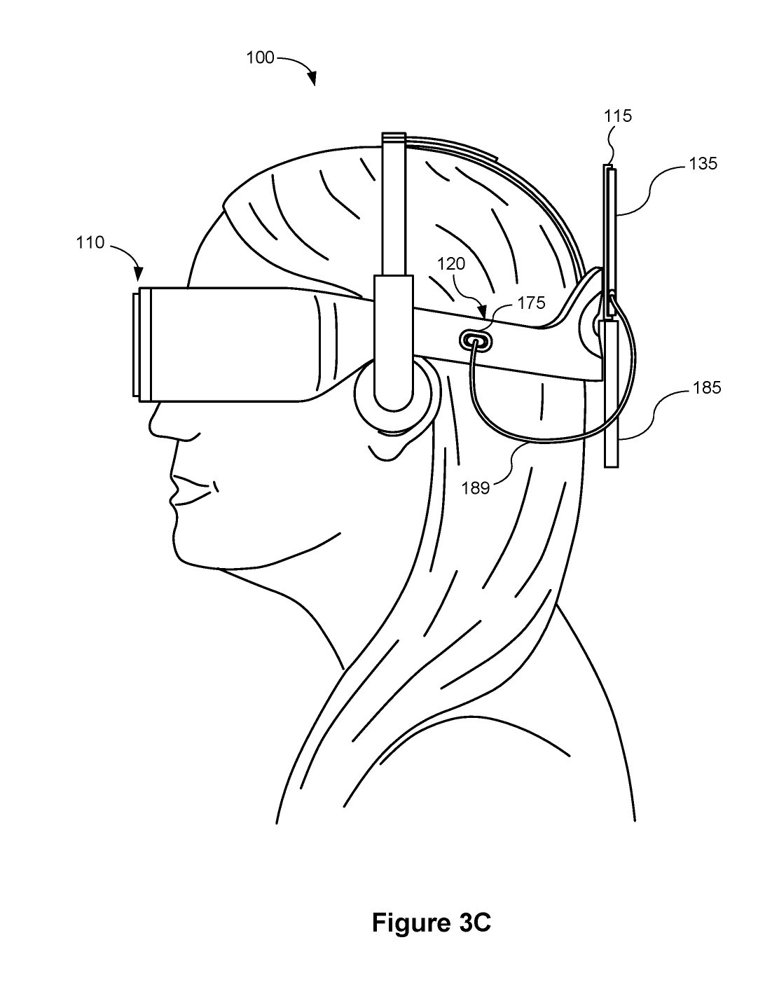

FIG. 1 is a side perspective view of a head-mounted display 110 coupled to a headband 120 of a virtual-reality (VR) system 100 in accordance with some embodiments. In some embodiments, the VR system 100 includes a head-mounted display (HMD) 110, a headband 120 to secure the HMD 110 on a user's head, and a holder 115 (FIGS. 3A-3C) mounted on the headband 120, to detachably support a mobile computer 135 (FIGS. 3A-3C) in a second mode of operation. In some embodiments, the holder 115 is detachably coupled to the headband 120 so as to be removable in the first mode of operation. In some embodiments, the VR system further includes an audio subsystem 180, which may be detachable.

As shown in FIG. 1, the head-mounted display 110 includes an opaque front cover 145 to cover the front of the head-mounted display 110, flexible circuits distributed inside the head-mounted display 110 (not shown), an opaque housing 155 to house components of the head-mounted display 110, a foam 165 coupled to the opaque housing 155 to rest against a user's face when the user wears the head-mounted display 110, and electrical connectors (e.g., cables, circuits, wires). The front cover 145 may be coupled to the housing 155 using one or more connectors, such as screws, by inserting the connectors through screw holes on the front cover 145. The front cover 145 and the opaque housing 155, when connected, may be considered a single opaque housing of the head-mounted display 110. In some embodiments, the housing 155 is opaque at visible wavelengths but not at infrared wavelengths.

Various embodiments of the head-mounted display 110 are described in U.S. patent application Ser. No. 14/861,910, filed on Sep. 22, 2015, the disclosure of which is incorporated herein by reference in its entirety.

In some embodiments, the head-mounted display 110 further includes a VR interface 175 positioned on an outer surface of the head-mounted display 110, or alternatively on the headband 120. The VR interface 175 may be a port through which the head-mounted display 110 is communicatively coupled to the stationary computer 125 in the first mode or the mobile computer 135 in the second mode. For example, the VR interface 175 may be, but is not limited to, a HDMI port through which video input is received from the stationary computer in the first mode and from the mobile computer in the second mode. Additionally the head-mounted display 110 may include a one or more interfaces through which additional data and power are received from at least one cable coupled to an auxiliary device (e.g. a hand-held controller or headphones) and/or a power source.

The headband 120 is used for mounting the head-mounted display 110 on a user's head. In the example of FIG. 1, the headband 120 comprises a rigid segment 130, a semi-rigid segment 140, and a rigid segment 150 that are coupled to each other to adjustably wrap around side and back portions of the user's head.

In some embodiments, the headband 120 comprises a single and continuous semi-rigid segment 140 including two arc portions, and each arc portion is to extend from above a user's ears to below the user's occipital lobe to conform to a portion of the user's head. Alternatively, the headband 120 may comprise two separate and symmetric semi-rigid segments each including an arc portion.

In some embodiments, the rigid segments 130 and 150 are respectively connected to the semi-rigid segment 140. The rigid segments 130 and 150 are also respectively coupled to the head-mounted display 110 and positioned on respective sides of the user's head to extend along the lateral dimension (e.g., the Z dimension in FIG. 1). The headband 120 may further include flexible segments (not shown) that are stretchable within the rigid segments 130 and 150 respectively to adjust the headband 120 in accordance with the user's head.

In some embodiments, the headband 120 comprises a back section 160 coupled with the semi-rigid segment 140 to rest against the back of the user's head (e.g., around the user's occipital lobe). The semi-rigid segment 140 extends to wrap around a portion at the back of the user' head (e.g., around the user's occipital lobe). The semi-rigid segment 140 includes a portion that conforms to the shape of the back section 160 and the back section 160 is coupled to the portion of the semi-rigid segment 140 at the back of the user's head. Alternatively, the headband 120 may have a back section that is part of a segment (e.g., the semi-rigid segment 140). The back section may be any part of the headband 120 against the back of the user's head.

In some embodiments, the headband 120 comprises a top strap 170 coupled to the back section 160 (or the semi-rigid segment 140) and the head-mounted display 110 to adjustably conform to the top of the user's head when the user is wearing the head-mounted display 110. In some embodiments, the VR interface 175 may be positioned on the top strap 170 or the rigid segment 150.

In some embodiments, various electrical connection mechanisms (e.g., flat flexible circuits and/or electric cables) are used in the VR system 100 to provide power management, signal transmission, and/or other functionalities to the head-mounted display 110 and the detachable audio subsystem 180. For example, the head-mounted display 110 is integrated with the detachable audio subsystem 180 using suitable electrical connection mechanisms to provide both visual and audio virtual-reality experiences to the user.

Various embodiments of the headband 120 and the head-mounted display 110 are described in U.S. patent application Ser. No. 14/603,335, filed on Jan. 22, 2015, and U.S. patent application Ser. No. 14/681,001, filed on Apr. 7, 2015, the disclosures of which are incorporated herein by reference in their entireties.

As discussed above, the headband 120 of the present disclosure is used for mounting the head-mounted display on a user's head. The headband 120 (e.g., the rigid guide segments and the back rigid piece) offers rigidity to balance the head-mounted display 110 on the user's head and provide accurate head-motion tracking. The headband 120 (e.g., the stretchable bands of the flexible segments and the semi-rigid segment) also provides adjustability to accommodate different users with different head sizes and shapes. In some embodiments, the rigid guide segments of headband 120 are rotatable relative to the head-mounted display 110 to allow a better compatibility with users' head and face geometries and wearing preferences. In some embodiments, the headband 120 comprises plastic materials, and thus is light-weight and comfortable to wear. When the user looks up and down or makes other head motions, the head-mounted display will not fall off the user's head.

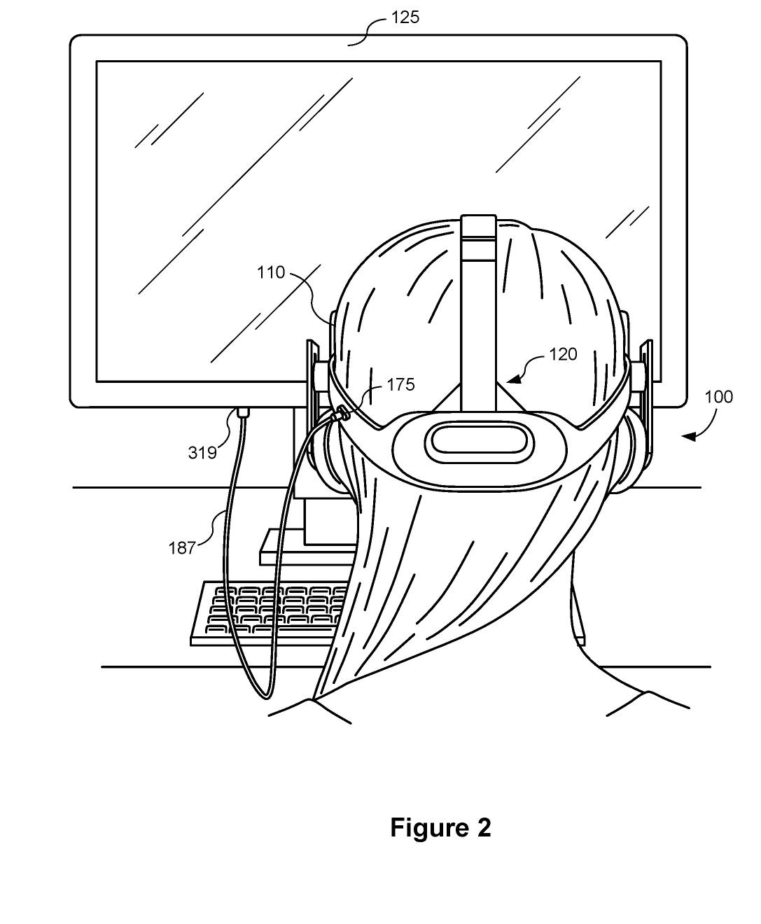

In some embodiments, as illustrated in FIGS. 3A-3C, the holder 115 is configured to support at least one of the mobile computer 135 and an additional power source 185 on the headband 120. (In the example of FIG. 2, the holder 115 has been detached from the headband 120 and is not shown.) The additional power source 185 is to provide additional power to the mobile device 135 during intensive VR use (e.g. high-CPU gameplay). In some embodiments, the power source 185 may be a lithium-polymer battery or a lithium-ion battery.

In some embodiments, the holder 115 is rotatably coupled to the back section 160 for adjustment of an angle of orientation of the mobile computer 135. The holder 115 may be rotatably coupled to the headband 120 through a bolt, a screw, or any other similar fastener. The holder 115 is mounted to the back section 160 of the headband 120 with at least one of the mobile computer 135 and the additional power source 185 supported (e.g., cradled) in the holder 115. The holder, with the mobile computer 135 and/or the additional power source 185 supported therein, is mounted on the back section 160 (e.g., at a center of the back section 160) to at least partially balance the weight of the HMD 110 on the user's head. This configuration provides the advantage of reducing fatigue of the user due to wearing the HMD. Conventional VR systems providing a mobile device mounted to the front of an HMD fail to provide this advantage as the additional weight of the mobile device in the conventional VR systems is exerted in the front of the HMD where the mobile device is mounted, thereby actually further contributing to the user fatigue.

In some embodiments, the holder 115 is integrally formed with the headband 120. In these embodiments, the holder 115 and the headband 120 form one continuous part. In other embodiments, the holder 115 is fixedly coupled to the headband 120. In these embodiments, the holder 115 may be sewn, stapled, mechanically fused (e.g. ultrasonically welded or melted) or otherwise connected to the headband 120. In other embodiments, the holder 115 is detachably coupled to the headband 120 and comprises at least one connector to couple to the headband 120. In some embodiments the at least one connector comprises first and second connectors provided at corresponding positions on each of the headband 120 and the holder 115 to couple the holder 115 to the headband 120.

In some embodiments, the at least one connector is permanently coupled to at least one of the holder 115 and the headband 120. For example, a first connector may be glued to the holder 115 and a second connector may be glued to the headband 120 at a position corresponding to the first connector so as to couple the holder 115 and the headband 120 to each other. Alternatively, each connector may be sewn, stapled, mechanically fused (e.g. ultrasonically welded or melted) or otherwise connected to the holder 115 and/or the headband 120. In other embodiments, each connector is detachably coupled to the holder 115 and/or the headband 120.

In some embodiments, the at least one connector comprises a magnet to magnetically couple the holder 115 and the headband 120 to each other.

In other embodiments the connector comprises a first connector which is a hook surface of a hook-and-loop fastener disposed on one of the holder 115 and the headband 120, and a second connector which is a loop surface of the hook-and-loop fastener disposed on the other of the holder 115 and the headband 120. The hooks are configured to hook and engage the loops thereby coupling the holder 115 and the headband 120.

In some embodiments the connector comprises a first disc on one of the headband 120 and the headset 110 and the second connector 170 comprises a second disc on the other of the headband 120 and the headset 110. The first disc has a protrusion protruding from one of the headband 120 and the headset 110. The second disc has a groove at a position on the other of the headband 120 and the headset 110 corresponding to a position of the protrusion on the first disc. The holder 115 and the headband 120 are detachably mated by insertion of the protrusion into the groove. In these embodiments, the connector comprises a snap fastener.

In some embodiments, at least one of a length and a width of the holder 115 is adjustable to accommodate a plurality of sizes of the mobile computer 135. In some embodiments, the holder 115 is formed of a rigid plastic material including, but not limited to high density polyethylene providing rigidity in structure. Alternatively, any other suitable materials may be used.

As described above, the VR system 100 of the present invention provides two modes of operation, using the same HMD, which allows for a user to view VR images based on high definition video processed by a stationary (e.g., desktop) computer 125 in the first mode and allows for the user to view VR images based on video processed by a mobile device 135 attached to the HMD 110, thereby removing physical constraints on the user's movements normally associated with connecting the HMD 110 to the stationary computer 125, in the second mode. This provides the user with the advantage of being able to view high-quality high-definition video during intensive VR use (e.g., gameplay) requiring high video processing power, in a first mode, and in a second mode utilizing a mobile computer 135 coupled to the headband 120 thereby offering greater freedom of movement not otherwise possible with the first mode where movement is restricted due to the cable coupling the HMD to the stationary computer 125.

In some embodiments, the VR system 100 further includes a first cable 187 (FIG. 2) to communicatively couple the stationary computer 125 to the HMD 110 in the first mode of operation and a second cable 189 (FIGS. 3A-3C) to communicatively couple the mobile computer 135 to the HMD 110 in the second mode of operation. The first cable 187 is longer than the second cable 189. In some embodiments, the first cable 187 and/or second cable 189 are HDMI cables or cables specific to particular computer-HMD combinations.

In some embodiments, the VR system 100 further comprises a plurality of light-emitting diodes (LEDs) 190 positioned on the HMD 110, on the headband 120 or on both the HMD 110 and the headband 120. In some embodiments, the plurality of light-emitting diodes (LEDs) 190 is distributed on outer surfaces (e.g., front, top, bottom, left-side, and/or right-side surfaces) of the head-mounted display 110 and/or the headband 120. For example, the LEDs 190 may be mounted on or embedded within the outer surface of the HMD 110 and/or the headband 120. The LEDs 190 may be infrared (IR) LEDs. In some embodiments, the IR LEDs are molded into the back section 160 of the headband 120 so that the IR LEDs are flush with the back section 160 yet still exposed. Alternatively, an IR transmissive material may be used on the back section 160 (e.g., on an outer surface of the back section 160). The IR LEDs are positioned under the outer surface of the back section 160 and covered by the IR transmissive material, so that IR light can still be transmitted through the outer surface of the back section 160. In some examples, the LEDs 190 are distributed along the edges of the back section 160. The LEDs 190 can also be arranged in any other suitable patterns. The rigidity of the back section 160 allows accurate positioning of the LEDs 190 for head-motion tracking. The LEDs 190, when working with a motion tracking video camera and the related software, provide head-motion tracking (e.g., over 360°) using the head-mounted display system in the first mode. In some embodiments, the LEDs 190 are activated in the first mode and disabled in the second mode, to save power. For example, the HMD 110 or mobile computer 135 includes one or more processors and memory (e.g., a non-transitory computer-readable medium) storing instructions that, when executed by the one or more processors, activate the LEDs 190 in the first mode and deactivate the LEDs 190 in the second mode.

The LEDs 190 are electrically connected to a power source which may or may not be the same power source providing power to the HMD 110 (e.g., additional power source 185 in the second mode). The HMD 110 may be wireless; therefore, the power source may be one or more batteries. The LEDs 190 may be housed in diffused cases including a current limiting resistor to keep the current from the power source to the LED below the LED's maximum current rating so as to ensure maximum life of the LEDs 190. The LEDs 190 may be activated in the first mode when a suitable voltage is applied. By virtue of the LEDs 190 being positioned in an area on the HMD 110 and/or headband 120 detectable by an external camera, motion of the light produced by the LEDs that is detected by the external camera is used as an indication of the positions and motion of the user's head, as described above. In this way, motion of the user's head is tracked by the camera, allowing for corresponding virtual-reality motions to be shown. For example, when the user shakes his/her head vigorously while playing a guitar during a VR activity, movement of the LEDs in a manner corresponding to the head shaking may be detected and used to model the user's motion.

To track motion of the user's head, the external camera captures a sequence of images of the HMD 110 and/or headband 120. Variation in positions of the LEDs 190 over time is used to determine movement, based on which motion of an image subject is modeled in virtual reality in accordance with actual physical head motions made by the user. Virtual-reality images are generated and presented to the user accordingly. The head-mounted display 110 is thus configured to display a view which shifts as a user shifts their head in some direction or tilts their head at an angle.

FIG. 2 is a back view of the virtual-reality (VR) system including the head-mounted display 110 communicatively coupled to the stationary computer 125 in the first mode of operation. In some embodiments, as illustrated in FIG. 2, in the first mode of operation, the HMD is communicatively coupled to the stationary computer 125 through the first cable 187. In the illustration of FIG. 2, the stationary computer 125 is a desktop computer and the first cable 187 is shown as being connected to the monitor of the desktop computer, however, the first cable may also be connected to an enclosure (e.g., the processing tower (CPU tower)) of the desktop computer. Since stationary computers (e.g. the desktop computer) generally have significantly greater processing power than mobile computers, the aforementioned configuration provides the high processing power for generating high-definition video to produce high-quality VR images which may not be possible using only a mobile computer to generate the video.

FIG. 3A is a back view and FIGS. 3B-3C are side perspective views of the virtual-reality (VR) system 100 including the head-mounted display 110 communicatively coupled to the mobile computer 135 in the second mode of operation. In some embodiments, as illustrated in FIGS. 3A-3C, in the second mode of operation, the HMD 110 is communicatively coupled to the mobile computer 125 through the second cable 189. The aforementioned configuration provides the advantage over the HMD 110 connected to the stationary computer 125 in that the user's movements are not physically constrained based on a length of the second cable 189. Because the mobile computer 135 is coupled to the headband 120 of the HMD 110, the user may freely move without interrupting the cable connection between the HMD 110 and the mobile computer 135.

In some embodiments, the first cable 187 is longer than the second cable 189. The first cable may for example be of a length ranging from about 0-20 feet, or about 5-15 feet, or about 8-12 feet, or in some cases approximately 10 feet. Such length provides consistently good video signal to the HMD 110 without significant degradation, while remaining reasonably light in weight so as to not overly constrain user movements. The second cable may for example be of a length ranging from 0-2 feet, or about 0.5 to 1.5 feet, or about 0.8 to 1.2 feet, or in some cases approximately 1 foot.

In some embodiments, the mobile computer 135 comprises at least one camera 137 to track a position of the user in the second mode. The camera 137 may be a rear-facing or a front-facing camera. As the user moves their head, variation in positions of the user's head over time are tracked by the camera 137 (e.g., by identifying and tracking the relative locations of external edges and/or objects) and used to determine movement of the HMD 110, based on which motion of an image subject is modeled in virtual reality in accordance with actual physical head motions made by the user. Virtual-reality images are generated and presented to the user accordingly. The HMD 110 is thus configured to display a view which shifts as a user shifts their head in some direction or tilts their head at an angle.

In some embodiments, a display 139 of the mobile computer 135 is configured to deactivate in the second mode to conserve power of the mobile computer 135. For example, a VR application on the mobile computer 135 includes instructions, stored in memory (e.g., in a non-transitory computer-readable medium), that when executed by a processor of the mobile computer 135 disable the display 139 in the second mode. In the second mode, the mobile computer 135 thus acts as a processing device processing video to be transmitted to the HMD 110 through the second cable 189, but does not display the video. Instead, the video is displayed on the HMD 110, thus conserving life of the battery of the mobile computer 135 or the additional power source 185.

In some embodiments, the mobile computer 135 includes at least one position sensor to track a motion of the user's head in the second mode. For example, the mobile computer 135 includes one or more sensors 320 (e.g. a gyroscope, or accelerometer) which provide sensor readings to the HMD 110 for use in image or video rendering. The sensor readings may include, but are not limited to, coordinates relating to various positions of the user's head during VR activities. The sensor readings are used by a VR application running on the mobile computer 135 and/or transmitted to the HMD 110 through the second cable 189 to the VR interface 175 of the HMD 110. In some embodiments, the HMD 110 includes one or more sensors (e.g., gyroscopes, accelerometers, magnetometers) which obtain sensor readings 104 for use in image or video rendering.

The VR system 100 thus provides an advantage in that the HMD is capable of displaying both high-quality VR images from a stationary computer and VR images from a mobile computer for which the user's freedom of movement is increased. Additionally, as described above, the aforementioned configuration of the mobile computer 135 supported in the holder 115 on the back portion 160 of the headband 120 provides the further advantage of balancing the HMD 110 on the user's head, thereby reducing fatigue of the user due to most of the weight otherwise being on the front of the user's head. Furthermore, mounting the mobile computer 135 on the back of the headband 120 reduces user fatigue, whereas systems that mount a mobile computer to the front of the HMD 110 actually increase user fatigue.

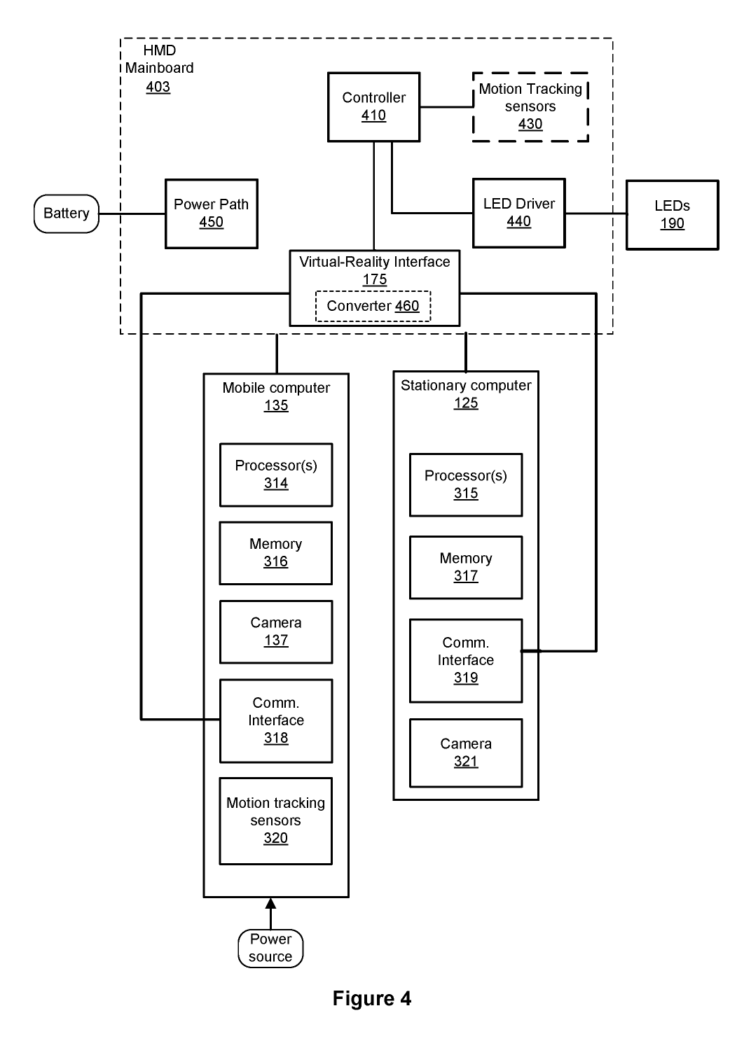

FIG. 4 is a block diagram illustrating an electrical configuration of an exemplary VR system (e.g., VR system 100) in accordance with some embodiments. In some embodiments, the VR system includes a mainboard 403. The mainboard 403 includes a controller 410, power path 450, motion/position tracking sensors 430, a VR interface 175, and a light-emitting diode (LED) driver 440. The mainboard 403 may be coupled to a power source (e.g., additional power source 185) to provide power to the HMD 110. The power may be supplied to the mainboard 403 through the power path 450.

In some embodiments, the VR interface 175 includes a converter 460 to convert video from a format provided by the mobile computer 135 and/or stationary computer 125 to a format processed by the HMD 110.

The LED driver 440 drives LEDs 190 under the control of the controller 410, and thus turns the LEDs 190 on in the first mode of operation and off in the second mode of operation. The mobile computer 135 comprises a processor 314, a camera 316, a communication interface 318, and motion tracking sensors 320. In the second mode, as described above, the controller 314 processes the VR video and transmits the processed video to the VR interface 175 of the HMD 110 through the communication interface 318 and the second cable 189. The stationary computer 125 comprises one or more processors 315, memory 317, a communication interface 319, and a camera 321. In the first mode, as described above, the processor(s) 315 processes the VR video and transmits the high-quality high-definition processed video to the VR interface 175 of the HMD 110 through the communication interface 319 and the first cable 187.

The motion tracking sensors 320, 430 include a plurality of motion sensors (e.g. accelerometers and/or gyroscopes) which tracks motion of the HMD 110 based on motions made by the user.

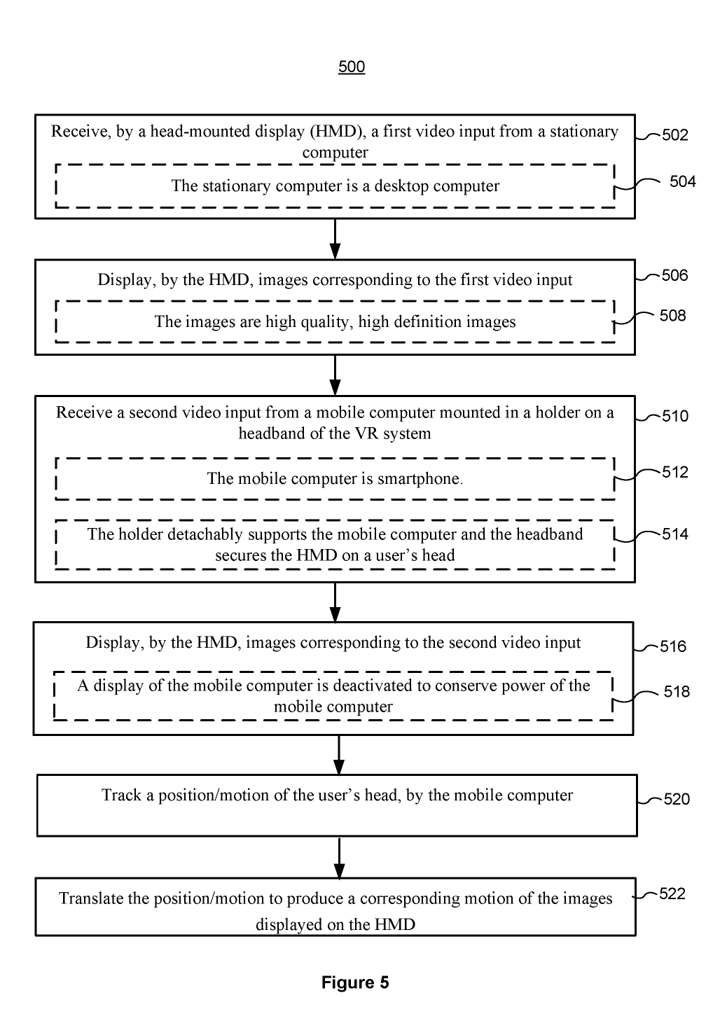

FIG. 5 is a flow diagram illustrating a method 500 of displaying virtual-reality (VR) images produced by a VR system (e.g., VR system 100) in accordance with some embodiments. In some embodiments, the method 500 for displaying VR images produced by the VR system 100 includes receiving (502), in a first mode of operation, by a HMD 110 of the VR system, a first video input from the stationary computer 125, and displaying (506), by the HMD 110, images corresponding to the first video input. In some embodiments (504), the stationary computer is a desktop computer. Due to the high processing power of the stationary computer as compared to a mobile computer, high-quality, high definition video is transmitted from the stationary computer to the HMD, thereby enhancing the feeling of “reality” a user experiences during VR activities. The method 500 further includes in a second mode of operation, receiving (510), by the HMD, a second video input from the mobile computer 135 mounted in the holder 115 on a headband 120 of the VR system. In some embodiments (512), the mobile computer 135 is a smartphone. In some embodiments (514), the holder 115 detachably supports the mobile computer 135 and the headband 120 secures the HMD on a user's head. The method further includes displaying (516), by the HMD 110, images corresponding to the second video input. In some embodiments, the method 400 further comprises, in the second mode, deactivating a display of the mobile computer (518) to conserve power of the mobile computer. In the second mode, the mobile computer 135 thus processes video to be transmitted to the HMD 110 through the second cable 189, but does not display the video, in accordance with some embodiments. Instead, the video is displayed on the HMD 110, thus conserving life of the battery of the mobile computer 135 or additional power supply 185.

As described above, in the first mode, the HMD 110 receives the first video input through the first cable 187 communicatively coupling the stationary computer 125 to the VR interface 175 of the HMD 110, and in the second mode, the HMD 110 receives the second video input through the second cable 197 communicatively coupling the mobile computer 135 to the VR interface 175, the second cable being shorter than the first cable. In some embodiments, the method 500 further comprises, in the second mode, tracking a motion of the user's head (520) by at least one motion-tracking sensor 320 of the mobile computer 135, and translating (522) the motion to produce a corresponding motion of the images displayed on the HMD 110. In other embodiments, the method further includes, in the second mode, tracking a position of the user, by at least one camera 137 of the mobile computer 135, to produce a corresponding motion of the images displayed on the HMD 110.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A virtual-reality (VR) system, comprising:
a head-mounted display (HMD) to receive video input from a stationary computer in a first mode of operation and from a mobile computer in a second mode of operation, and to display images corresponding to the video input;
a headband to secure the HMD on a user's head; and
a holder mounted on the headband to detachably support the mobile computer.

2. The virtual-reality system of claim 1, further comprising:
a first cable to communicatively couple the stationary computer to the HMD in the first mode of operation; and
a second cable to communicatively couple the mobile computer to the HMD in the second mode of operation,
wherein the second cable is shorter than the first cable.

3. The virtual-reality system of claim 2, wherein:
the HMD comprises an interface positioned on an outer surface of the HMD to allow for access during switching between the first and second modes;
the first cable communicatively couples the stationary computer to the HMD, through the interface, in the first mode of operation; and
the second cable communicatively couples the mobile computer to the HMD, through the interface, in the second mode of operation.

4. The virtual-reality system of claim 2, wherein the mobile computer comprises at least one position sensor to track a motion of the user's head in the second mode.

5. The virtual-reality system of claim 2, wherein the mobile computer comprises at least one camera to track a position of the user in the second mode.

6. The virtual-reality system of claim 1, wherein the holder is mounted to a back section of the headband to at least partially balance a weight of the HMD on the user's head when the mobile computer is supported in the holder.

7. The virtual-reality system of claim 6, wherein the holder is configured to support the mobile computer and a power source on the headband.

8. The virtual-reality system of claim 7, wherein the power source comprises a battery selected from the group consisting of a lithium-polymer battery and a lithium-ion battery.

9. The virtual-reality system of claim 6, wherein the holder is rotatably coupled to the back section for adjustment of an angle of orientation of the mobile computer.

10. The virtual-reality system of claim 6, wherein the holder is detachably coupled to the back section.

11. The virtual-reality system of claim 6, wherein the holder is integrally formed with the back section.

12. The virtual-reality system of claim 6, wherein the holder is adjustable to accommodate a plurality of sizes of the mobile computer.

13. The virtual-reality system of claim 1, wherein a display of the mobile computer is configured to deactivate in the second mode to conserve power of the mobile computer.

14. The virtual-reality system of claim 1, further comprising a plurality of light-emitting diodes (LEDs) coupled to at least one of the HMD and the headband, wherein the plurality of LEDs is configured to be activated in the first mode and deactivated in the second mode.

15. A method for displaying virtual-reality (VR) images produced by a VR system, the method comprising:
in a first mode of operation:
receiving, by a head-mounted display (HMD) of the VR system, a first video input from a stationary computer; and
displaying, by the HMD, images corresponding to the first video input; and
in a second mode of operation:
receiving, by the HMD, a second video input from a mobile computer mounted in a holder on a headband of the VR system, wherein the holder is configured to detachably support the mobile computer and the headband is configured to secure the HMD on a user's head; and
displaying, by the HMD, images corresponding to the second video input.

16. The method of claim 15, further comprising, in the second mode, deactivating a display of the mobile computer to conserve power.

17. The method of claim 15, wherein:
in the first mode, the HMD receives the first video input through a first cable communicatively coupling the stationary computer to a VR interface of the HMD;
in the second mode, the HMD receives the second video input through a second cable communicatively coupling the mobile computer to the VR interface; and
the second cable is shorter than the first cable.

18. The method of claim 15, wherein the holder is mounted to a back section of the headband to at least partially balance a weight of the HMD on the user's head when the user wears the HMD.

19. The method of claim 15, further comprising, in the second mode:
tracking a motion of the user's head, by at least one position sensor of the mobile computer; and
translating the motion to produce a corresponding motion of the images displayed on the HMD.

20. The method of claim 15, further comprising, in the second mode, tracking a position of the user, by at least one camera of the mobile computer, to produce a corresponding motion of the images displayed on the HMD.
